(19) United States
(12) Patent Application Publication
(10) Pub. No.: US 2023/0421030 A1
(43) Pub. Date: Dec. 28, 2023

(54) APPARATUS FOR BENDING AND EXPANDING HAIRPINS OF HAIRPIN MOTOR OF ELECTRIC VEHICLE

(71) Applicants: Hyundai Motor Company, Seoul (KR); Kia Corporation, Seoul (KR)

(72) Inventor: Seung Kyu Jang, Suwon (KR)

(21) Appl. No.: 18/195,110

(22) Filed: May 9, 2023

(30) Foreign Application Priority Data
Jun. 23, 2022 (KR) 10-2022-0076976
Jan. 3, 2023 (KR) 10-2023-0000816

(51) Int. Cl. H02K 15/00; B21F 3/02

(52) U.S. Cl. CPC H02K 15/0087; B21F 3/02

(57) ABSTRACT

An apparatus for bending and expanding hairpins of a hairpin motor includes a holder on which a stator of the hairpin motor coupled to the hairpins is mounted, and a driving unit including a jig that fixes the hairpins, a first actuator connected to the jig to rotate the jig so that the plurality of hairpins is bent, and a second actuator connected to the jig and configured to move the jig in a state in which the hairpins are fixed by the jig so that the hairpins are expanded outwardly from a center of the stator.

### CROSS REFERENCE TO RELATED APPLICATION

The present application claims under 35 U.S.C. § 119(a) the benefit of Korean Patent Application Nos. 10-2022-0076976, filed on Jun. 23, 2022, and 10-2023-0000816, filed on Jan. 3, 2023, the entire contents of which are incorporated by reference herein.

### BACKGROUND

### (a) Technical Field

The present disclosure relates to an apparatus for bending and expanding hairpins of a hairpin motor, more particularly, to an apparatus capable of carrying out a bending and expanding process simultaneously on the hairpins of the hairpin motor, which constitutes an electric motor provided in a vehicle, e.g., a hybrid or electric vehicle.

### (b) Description of the Related Art

In general, it is known that the output of a motor (i.e., an electric motor) is proportional to the number of turns wound around a stator core of a stator of the motor. However, as the number of turns is increased, the size of a stator core is increased, and thus the size of the electric motor will inevitably be larger. Therefore, research has been actively conducted on a method of improving the output of the motor without increasing the size of the motor.

To improve motor output, a study has been conducted on a method for using a flat coil with a quadrilateral cross-section in the coil with a circular cross section. As such, since the flat coil (referred to as a hairpin) is thick, winding the coil is difficult, and thus a method to form the motor has evolved in which a plurality of separated hairpins is inserted into the stator coil and the end of the hairpin is welded and joined to form the windings of the coil. The hairpin winding motor is currently widely used, as it overcomes certain constraints of a winding machine and allows easy coil windings even in the case of the flat coil.

However, unlike a method of using a winding machine, the conventional hairpin winding motor requires a long working time as repetitive welding is performed, which may lead to low productivity. There is also a problem of low durability caused by a contact defect and welding defect around the welding joint of each hairpin.

Due to such problems conventionally, an aligner apparatus has been developed that aligns the welded joint of the hairpin. However, due to the many steps required to align the hairpins, the work time has not been appreciably shortened. In addition, during a process of partitioning or aligning the hairpins in pairs, ends of the hairpins may be damaged, which may cause frequent malfunctions and welding defects of the apparatus.

Accordingly, a separate working process or development of an apparatus to prevent damage of the hairpins when aligning the hairpins is necessary.

The foregoing is intended merely to aid in the understanding of the background of the present disclosure, and is not intended to mean that the present disclosure falls within the purview of the related art that is already known to those skilled in the art.

### SUMMARY

Therefore, the present disclosure provides an apparatus capable of simultaneously bending and expanding a plurality of hairpins provided on a stator of a hairpin motor to be aligned and welded. The hairpin motor may be an electric motor provided in a vehicle, e.g., a hybrid or electric vehicle.

The apparatus for bending and expanding a plurality of hairpins of a hairpin motor according to the present disclosure includes: a holder on which a stator of the hairpin motor coupled to the plurality of hairpins is mounted; and including a jig that fixes the plurality of hairpins, and a driving unit includes a first actuator connected to the jig to rotate the jig so that the plurality of hairpins is bent, and a second actuator connected to the jig and configured to move the jig so that each of the hairpins is expanded outwardly from the center of the stator.

An ascending and descending apparatus may further be included in which the stator is mounted on the holder so that the plurality of hairpins faces downward, the driving unit is disposed on a bottom portion of the holder, and the driving unit moves upward and downward directions from the bottom portion of the holder so that the jig is inserted into or separated from the hairpins.

The ascending and descending apparatus may include a first motor and a connecting link connected to a rotating shaft of a first driving motor to move the driving unit in upward and downward directions.

The holder includes a supporting unit extending in a vertical direction, and a mounting unit coupled to an upper portion of the supporting unit and having the stator mounted thereon.

The driving unit may include a main plate connected to the holder and configured to be movable in upward and downward directions, and a support extending upward from the main plate and having an upper portion on which the jig is disposed.

The driving unit may further include a guide plate disposed on the upper portion of the support and connected to the jig to rotate the jig, and a rotating plate configured to rotate relative to the guide plate to guide the jig to expand the jig from a center portion to the outside.

The first actuator may include a second driving motor driven to rotate the rotating shaft, and a first connecting gear connecting the second driving motor and the guide plate and rotate the guide plate with respect to a center of the guide plate.

The second actuator may include a third driving motor driven to rotate the rotating shaft and a second connecting gear that connects a third driving motor and the rotating plate so that the jig moves to the center of the guide plate or from the center of the guide plate to the outside.

The driving unit may further include a bearing unit configured to connect the guide plate and the support and allow the guide plate to freely rotate on the upper portion of the support.

The first actuator and the second actuator may be operated simultaneously.

The hairpin motor may be an electric motor included in a vehicle.

An electric vehicle may include the above-described hairpin motor.

An apparatus for bending or expanding hairpins of a hairpin motor according to the present disclosure has an effect in that a process is simplified, and therefore, the manufacturing cost and time may be reduced by performing two processes in one apparatus, which includes a process of bending and expanding the hairpin of the hairpin motor.

### BRIEF DESCRIPTION OF THE DRAWINGS

FIG. 1 is a side view illustrating an apparatus for bending and expanding hairpins of a hairpin motor according to one embodiment of the present disclosure.

FIGS. 2 and 3 are side views illustrating a driving unit included in the apparatus for bending and expanding the hairpins of the hairpin motor according in FIG. 1.

FIG. 4 is a perspective view illustrating an apparatus for bending and expanding hairpins of a hairpin motor according to one embodiment of the present disclosure.

FIG. 5 is a side view of the apparatus for bending and expanding the hairpins of the hairpin motor in FIG. 4.

FIG. 6 is a view illustrating a guide plate of the present disclosure.

FIG. 7 is a view illustrating a jig installed in a guide plate of the present disclosure.

FIG. 8 is a view illustrating a rotating plate of the present disclosure.

FIG. 9 is a projection view in which a guide plate, a jig, and a rotating plate of the present disclosure are overlapped.

FIGS. 10 and 11 are views illustrating sequential operations of a hairpin bending and extending apparatus of a hairpin motor according to an embodiment of the present disclosure.

### DETAILED DESCRIPTION

Regarding embodiments of the present disclosure disclosed in this specification or application, the specific structural or functional description is merely illustrative for the purpose of describing the embodiments of the disclosure, and embodiments of the disclosure may be implemented in various forms but not be construed as being limited to the embodiments set forth in this specification or application.

Because the embodiments of the disclosure may be variously modified and have various forms, specific embodiments will be illustrated in the drawings and described in detail in this specification or application. However, embodiments of the disclosure are intended not to be limited to the specific embodiments but to cover all modifications, equivalents, or alternatives without departing from the spirit and technical scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present. Meanwhile, other expressions describing relationships between components such as “between”, “immediately between” or “adjacent to” and “directly adjacent to” may be construed similarly.

The terms used in the present specification are merely used to describe specific embodiments and are not intended to limit the present disclosure. As used herein, the singular form is intended to include the plural forms as well, unless context clearly indicates otherwise. In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

Unless defined otherwise, all technical and scientific terms used herein have the same meaning as commonly understood by one of ordinary skill in the art to which this inventive concept belongs. It will be further understood that terms defined in commonly used dictionaries should be interpreted as having a meaning that is consistent with their meaning in the context of the related art and will not be interpreted in an idealized or overly formal sense unless expressly so defined herein.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter embodiments of the present disclosure will be described in greater detail with reference to the accompanying drawings. Like numerals refer to like elements throughout.

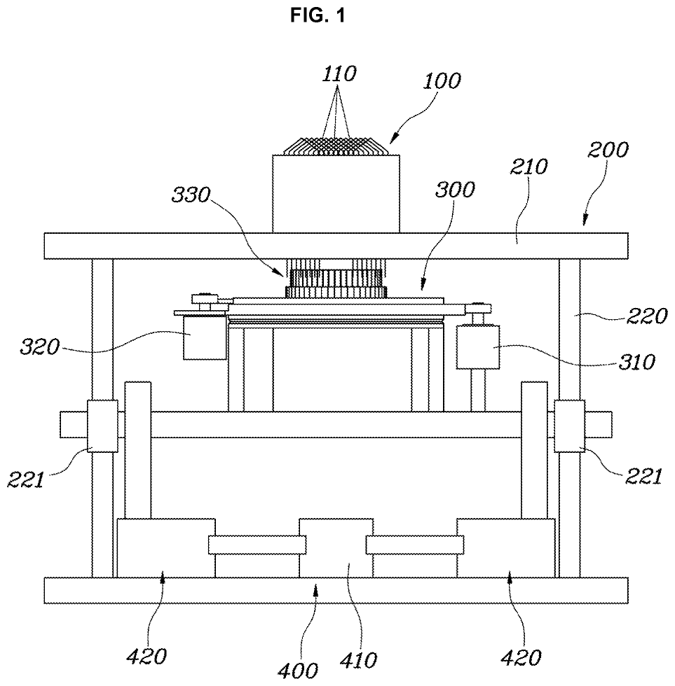

A preferred embodiment of the apparatus for bending and expanding hairpins 110 of a hairpin motor according to the present disclosure is described with a reference to FIGS. 1 to 6.

An electric motor operated by having the electric power as an input may be provided with a rotor and a stator 100, any one of the rotor and the stator 100 may be provided with a magnetic body or a coil.

The coil of the motor is formed by one metallic wire and wound around the stator 100 or the rotor, or hairpins 110 may be formed by twisting a plurality of hairpins 110.

The hairpin motor as applied to the hairpins 110 bends the plurality of hairpins 110 provided on the stator 100 or the rotor and expanded outwardly to make connections to each other. The hairpin motor according to the present disclosure is an apparatus configured to bend and expand the hairpins 110.

An apparatus for bending and expanding one or more hairpins 110 of a hairpin motor according to the present disclosure specifically includes: a holder 200 on which a stator of the hairpin motor coupled to the plurality of hairpins 110 is mounted; and a driving unit 300 comprising a jig 330 that fixes the plurality of hairpins 110, a first actuator 310 connected to the jig 330 to rotate the jig 330 so that the plurality of hairpins 110 is bent, and a second actuator 320 connected to the jig 330 and configured to move the jig 330 in a state in which the hairpins 110 are fixed by the jig 330 so that the hairpin 110 is expanded outwardly from the center of the stator 100.

As illustrated in FIG. 1, the holder 200 may provide a mounting space in which the stator 100 of the hairpin motor provided with the hairpins 110, thereby the stator 100 of the hairpin motor is fixedly mounted.

As mentioned above, it is illustrated that the hairpins 110 are provided in the stator 100. However, the hairpins 110 may be provided in the rotor, instead of the stator 100, and the magnetic body provided on the stator 100.

The stator 100 in which the plurality of hairpins 110 is provided is mounted on the holder 200, and the jig 330 that holds the hairpins 110 by inserting the plurality of hairpins 110 is provided in the driving unit 300. In the driving unit 300, the first actuator 310, where the jig 330 that holds the hairpins 110 is rotated, and the plurality of hairpins 110 is bent to the direction about which the jig 330 is rotated, and the second actuator 320 that moves the jig 330 outwardly to expand the hairpins 110 towards the outside from the center of the stator 100.

The jig 330 is configured to have the corresponding number of hairpins 110, the hairpins 110 are coupled to the stator 100, and the jig 330 is aligned in a circle to hold the hairpins 110. In addition, the jig 330 may form a groove in which the hairpins 110 are inserted to hold the hairpins 110.

By rotating the entire jig 330 with respect to the center of the stator 100, the first actuator 310 may bend the hairpins 110 in the direction of the jig 330 rotating with respect to the center of the stator 100.

In addition, in the second actuator 320, each of the jig 330 is moved to the outside with respect to the center of the stator 100, the hairpins 110 that hold the jig 330 may expand outwardly with respect to the center of stator 100.

Accordingly, the apparatus for bending and expanding the hairpins 110 of the hairpin motor according to the present disclosure has an effect in that a process is simplified, and therefore, the manufacturing cost and time may be reduced by performing two processes in one apparatus simultaneously, which includes a process of bending and expanding the hairpins 110 of the hairpin motor.

An ascending and descending apparatus 400 may further be included in which the stator 100 is mounted on the holder 200 so that the plurality of hairpins 110 faces downward, the driving unit 300 is disposed on the bottom portion of the holder 200, and the driving unit 300 moves upward and downward directions from the bottom portion of the holder 200 so that the jig 330 is inserted into or separated from the hairpins 110.

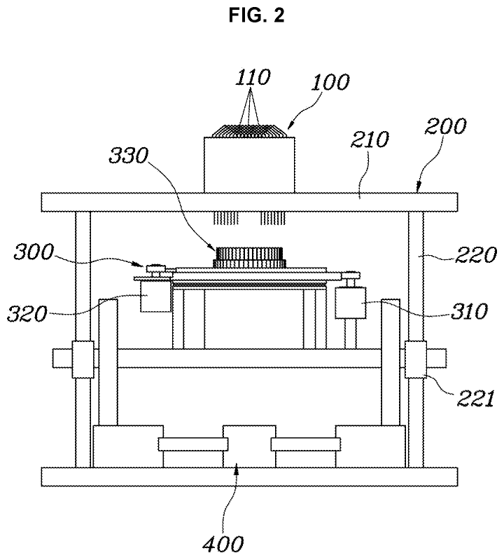

As illustrated in FIG. 2, the stator 100 provided with the hairpins 110 of the hairpin motor mounted on the holder 200 in a state where the hairpin 110 faces downward, the driving unit 300 is disposed such that the jig 330 disposed to face the hairpins 110 in upward and downward directions, and located at the bottom portion of the holder 200. The ascending and descending apparatus 400 for moving the driving unit 300 in the vertical direction so that the hairpins 110 are inserted into the jig 330 and holds the hairpins 110 may be provided.

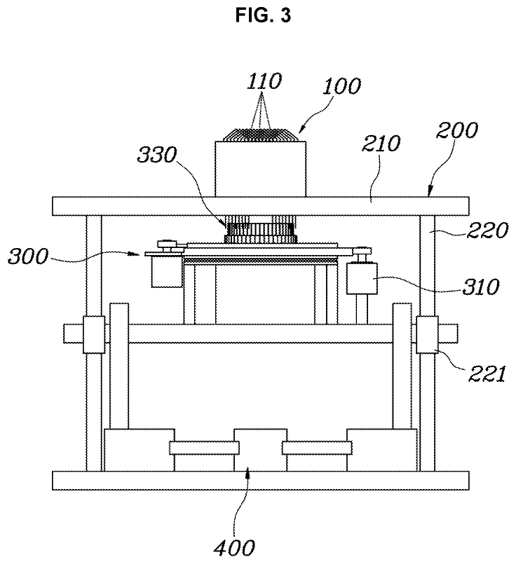

As illustrated in FIGS. 2 and 3, the driving unit 300 is disposed downward from the lower portion of the holder 200 before the stator 100 is 100 is mounted on the holder 200. After the stator 100 is mounted on the holder 200, the driving unit 300 is moved vertically by the ascending and descending apparatus 400, and after the jig 330 holds the hairpins 110, the first actuator 310 and the second actuator 320 are operated to bend and expand the hairpins 110 and move back down by the ascending and descending apparatus 400.

After the stator 100 having the hairpins 110 bent and expanded may move to the next process.

The ascending and descending apparatus 400 may include a first driving motor 410 and a connecting link 420 for moving the driving unit 300 in the upward and downward directions by connected to the rotating shaft of the first driving motor 410.

As illustrated in FIG. 1, the ascending and descending apparatus 400, specifically, is provided with the first driving motor 410 that operates to rotate the rotating shaft by applying the power externally, and the connecting link 420 that ascends and descends the driving unit 300 by connecting the rotating shaft of the first driving motor 410 and the driving 300, thereby moving the driving unit 300 in upward and downward directions.

The connecting link 420, specifically, is configured with a first screw connecting to the rotating shaft of the first driving motor 410, a screw jack changing the first screw in upward and downward directions, and a second screw moving the driving unit 300 in upward and downward directions by connecting the screw jack and the driving unit 300, such a configuration is an embodiment of the connecting link 420, and the connecting link 420 may be formed in various configurations.

The holder 200 is coupled to the supporting unit 220 extended towards the vertical direction and the upper portion of the supporting unit 220 and includes a mounting unit 210 mounting the stator 100, and the driving unit 300 may include a bush that is connected to the supporting unit 220 to support when moving in the vertical direction.

As illustrated in FIGS. 1 to 3, the holder 200 may include the supporting unit 220 extending in upward and downward directions, and a plurality of supporting units 220 and a mounting unit 210 connected to an upper-end portion of the plurality of supporting units 220 and mounted with the stator 100.

The driving unit 300 is provided on the bottom portion of the mounting unit 210, moved in upward and downward directions along with the supporting unit 220 by connecting to the supporting 220 to be movable in the vertical direction, and hold the hairpins 110 of the stator in which the jig 330 is mounted on the mounting unit 210.

At this time, the driving unit 300 may be connected to the supporting unit 220 by the bush, and the bush may connect the driving unit 300 and the supporting unit 220 for moving stably when the driving unit 300 is moved in the upward and downward directions.

The driving unit 300 may include a main plate 340 connected to the supporting unit 200 for moving in the vertical direction, and a support 350 in which the jig 330 is disposed on the upper portion extended in upward and downward directions from the main plate 340.

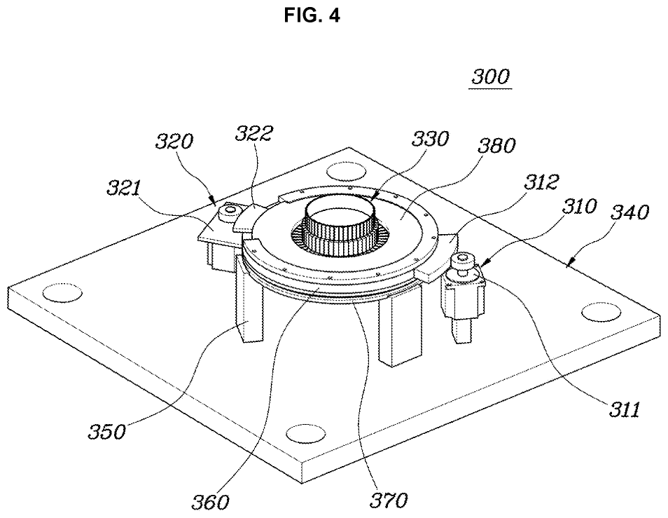

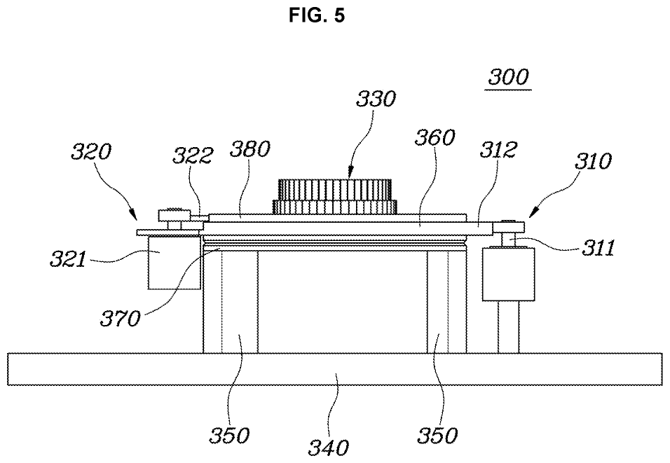

As illustrated in FIGS. 4 and 5, the driving unit 300 is connected to the supporting unit 220 of the holder 200 for moving upward and downward directions, the main plate 340 is provided which forms the bottom portion of the driving unit 300, and the support 350 is provided in which the jig 330 is connected to the upper portion configured to extend upward from a top surface of the main plate 340.

The main plate 340 is connected to the supporting unit 220 of the holder 200 to be movable in the upward and downward directions by a bush and move upward and downward directions by the ascending and descending apparatus 400, and the plurality of hairpins 110 is inserted so as to the jig 330 connected on the upper portion of the support 350 holds the hairpins 110.

The first actuator 310 is connected to the jig 330 and may be supported by connecting to the main plate 340.

The driving unit 300 may further include a guide plate 360 disposed on the upper portion of the support 350 and connected to the jig 330 to guide the rotation of the jig 330.

As illustrated in FIGS. 4 and 5, the guide plate 360 provided on the upper portion of the support 350 is connected to the jig 330 and may be connected to the first actuator 310 to guide the rotation of the jig 330 rotates in one direction from the center portion of the stator 100 when the first actuator is operated.

In addition, the second actuator 320 is connected to the guide plate 360 so that the second actuator 320 rotates and moves together when the guide plate 360 rotates. The rotating plate 380 is installed above the guide plate 360 so as to be relatively rotated. The rotating plate 380 is rotated by the second actuator 320. The rotating plate 380 is connected to a plurality of jigs 330 so that when the rotating plate 380 rotates, the jig 330 expands in the radial direction, not in the rotation. Accordingly, when the first actuator 310 is twisted through the rotation of the jig 330, and when the second actuator 320 is driven, the hairpins 110 are widened through the expansion movement of the jig 330.

The rotation and expansion movement of the jig 330 may be guided by the guide plate 360 and the rotating plate 380 by operating the first actuator 310 and the second actuator 320.

The first actuator 310 may include a second driving motor 311 driven to rotate the rotating shaft, and a first connecting gear 312 connecting the second driving motor 311 and the guide plate 360 to rotate the guide plate 360 with respect to the center.

As illustrated in FIG. 5, the first actuator 310 include the second driving motor 311 operated to rotate a rotating shaft, and the first connecting gear 312 connecting the jig 330 and the second driving motor 311 to rotate the jig 330.

The second actuator 320 is fixed to the guide plate 360 and rotated together with the guide plate 360. In addition, the second actuator 320 is provided with a rotating plate 380 connected to the jig 330 while being rotated relative to the guide plate 360 by the third driving motor 321 and the third driving motor 321 driven to rotate the rotating shaft. The jig 330 is moved outwardly or toward the center from the center of the guide plate 360 on the guide plate 360 by relative rotation of the rotating plate 380. The rotating plate 380 receives the rotational force from the third driving motor 321 through the second connecting gear 322.

The driving unit 300 may further include a bearing unit 370 connecting the guide plate 360 and the support 350 so that the guide plate 360 is freely rotated at the upper portion of the support 350.

As illustrated in FIGS. 4 and 5, the bearing unit 370 is provided to connect the upper portion of the support 350 to rotate the guide plate 360 and the jig 330 freely, and the first actuator 310 is operated so that the guide plate 360 and the jig 330 may freely rotate on the upper portion of the support 350. In addition, the rotating plate may be installed on the upper portion of the guide plate 360 so that the jig may be extended and moved on the guide plate.

In addition, the first actuator 310 and the second actuator 320 may be operated simultaneously, accordingly, twisting, and widening of the hairpins 110 may be implemented simultaneously.

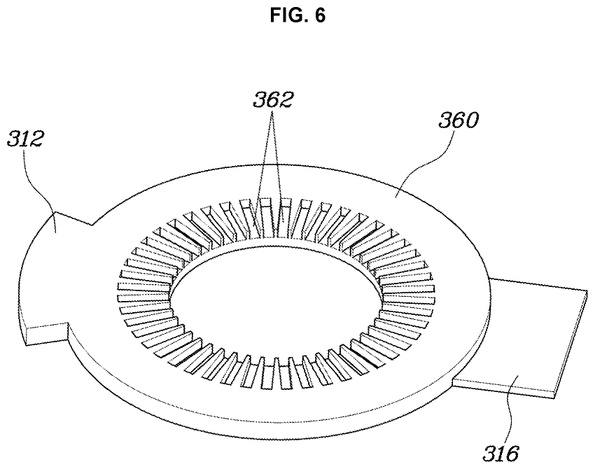

Specifically, FIG. 6 is a view illustrating a guide plate 360 of the present disclosure. The guide plate 360 is provided with a first connecting gear 312 on one side, and the first connecting gear 312 is connected to the first actuator 310 to receive rotational force. The other side of the guide plate 360 is formed with a mounting unit 316, and the second actuator 320 is installed on the mounting unit 316. Therefore, when the first actuator 310 is driven, the guide plate 360 and the second actuator 320 are rotated together. The guide plate 360 extends in the radial direction and a plurality of jig grooves 362 arranged radially are formed, and by inserting each jig 330 into each jig groove 362, the jig 330 rotates together when the guide plate 360 rotates, and thus, the entire twisting of the hairpins 110 is implemented.

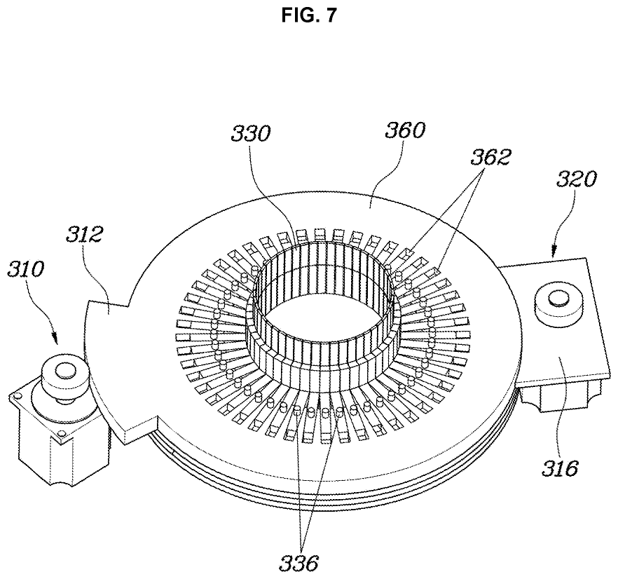

FIG. 7 is a view illustrating a jig installed in a guide plate of the present disclosure, in which it may be seen that when the guide plate 360 is rotated, the jigs 330 may also be rotated.

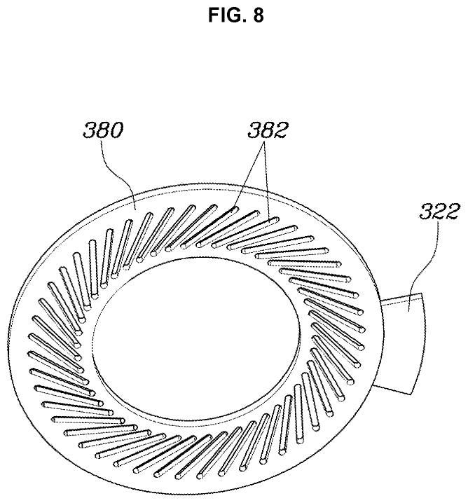

On the other hand, each of the jig 330 is formed with a pin 336 protruding upward. FIG. 8 illustrates a state in which the rotating plate 380 is viewed from the bottom. The rotating plate 380 is installed above the guide plate 360 to allow relative rotation. In addition, the jig pin 336 is inserted on the lower surface of the rotating plate 380, that is, the surface facing the guide plate 360, to form a guide groove 382 for guiding the jig pin 336. A plurality of guide grooves 382 are radially arranged and formed in a diagonal direction, and the pin 336 of the jig is guided in an outer or inner radial direction when the rotating plate 380 rotates.

Since the rotating plate 380 rotates relative to the guide plate 360 through the second actuator 320, by driving the second actuator 320, the jig 330 may not be rotated due to the restriction of the guide plate 360, and jig 330 may only be extended and moved in the radial direction on the jig groove 362 of the guide plate 360 by the rotating plate 380 that rotates relatively at a predetermined angle. Accordingly, the entire hairpins 110 is widened.

Therefore, the hairpins 110 are twisted through the rotation of the guide plate 360, and at the same time, widening is simultaneously implemented due to the rotating plate 380 further rotating with respect to the guide plate 360.

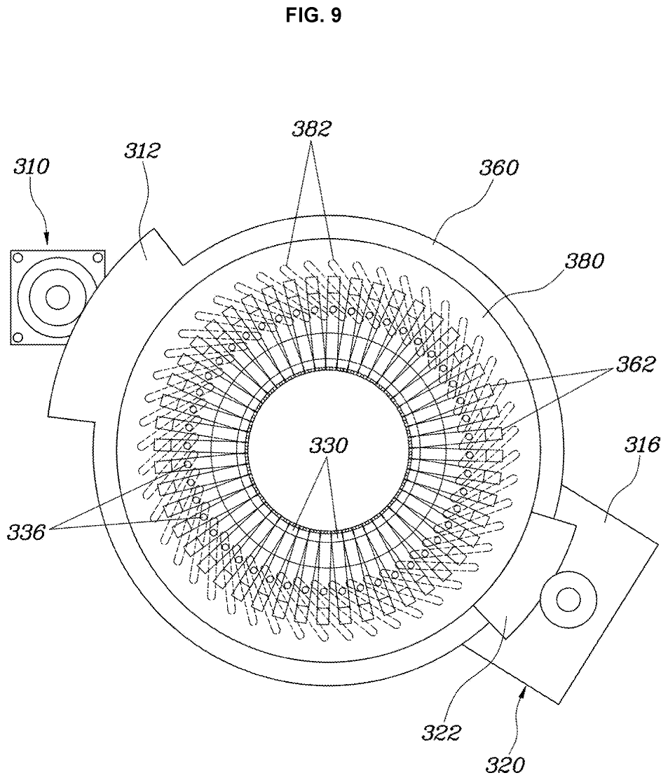

FIG. 9 is a projection view illustrating a state in which the guide plate 360, the jig 330, and the rotating plate 380 overlap each other. As shown in the drawing, the guide plate 360 is rotated, the guide plate 360, and the rotating plate 380 are rotated together to twist the hairpins 110. Further, if only the rotating plate 380 is rotated, and as for the jig 380, since rotation cannot be performed due to being constrained by the guide plate 360, only movement in the radial direction is possible by the diagonal guide grooves 382 of the rotating plate 380. In the drawing, it can be seen that when the rotating plate 380 is rotated in the clockwise direction, the pin 336 of the jig may slide radially outwardly by the guide groove 382. Accordingly, the widening of the hairpins 110 may be implemented.

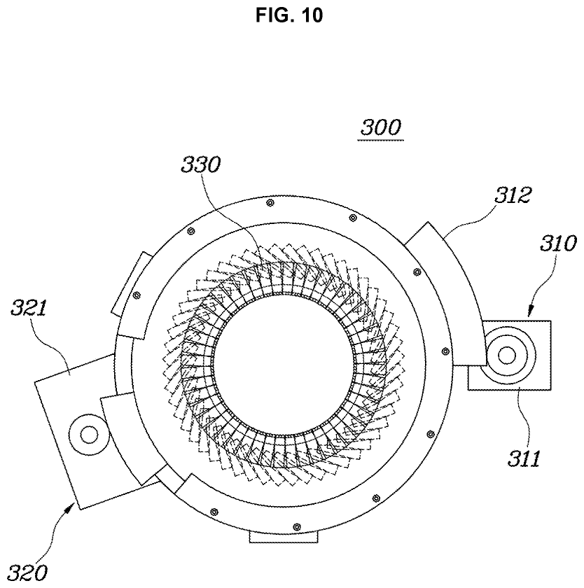

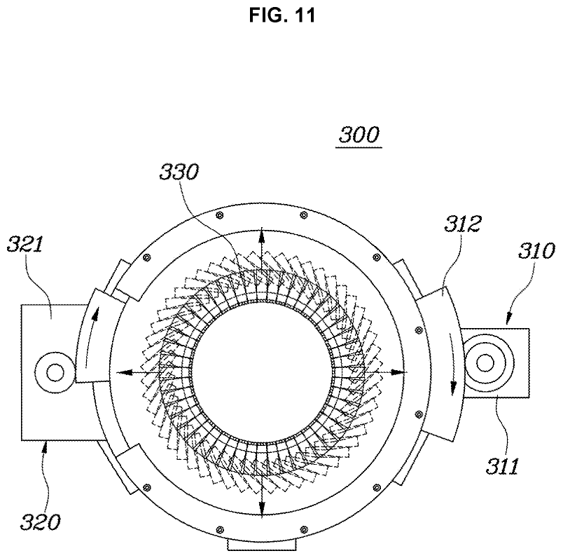

FIGS. 10 and 11 are views illustrating sequential operations of a hairpin bending and extending apparatus of the present disclosure. Referring to FIG. 10, after the jig 330 holds the hairpins 110 of the stator 100 by the ascending and descending apparatus 400, the first actuator 310 and the second actuator 320 provided in the driving unit 300 are operated simultaneously to twist the hairpins 110 by the rotation of the guide plate 360 and the hairpins 110 is widened by the additional relative rotation of the rotating plate 380, as shown in FIG. 11. In other words, when the guide plate 360 and the rotating plate 380 are rotated together in the clockwise direction, the hairpins 110 may be extended outwardly from the center of the stator 100 and simultaneously rotated in one direction to be bent.

Therefore, two processes of the hairpins 110 to expand outwardly from the center of the stator 100 and bend in one direction are performed at once, thereby reducing the work time and simplifying the process so that the manufacturing cost is significantly reduced.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An apparatus for bending and expanding a plurality of hairpins of a hairpin motor, the apparatus comprising:
a holder on which a stator of a hairpin motor coupled to the plurality of hairpins is mounted; and
a driving unit comprising a jig that fixes the plurality of hairpins, a first actuator connected to the jig to rotate the jig so that the plurality of hairpins is bent, and a second actuator connected to the jig and configured to move the jig in a state in which the hairpins are fixed by the jig so that each of the hairpins is expanded outwardly from a center of the stator.

2. The apparatus of claim 1, wherein the stator is mounted on the holder so that the plurality of hairpins faces downwardly, and the driving unit is disposed on a bottom portion of the holder, and
wherein the apparatus further comprises an ascending and descending apparatus configured to move the driving unit upward and downward directions from the bottom portion so that the jig is inserted into or separated from the hairpin.

3. The apparatus of claim 2, wherein the ascending and descending apparatus comprises:
a first driving motor; and
a connecting link connected to a rotating shaft of the first driving motor to move the driving unit in upward and downward directions.

4. The apparatus of claim 1, wherein the holder comprises:
a supporting unit extending in an upward and downward directions; and
a mounting unit coupled to an upper portion of the supporting unit and having the stator mounted thereon.

5. The apparatus of claim 1, wherein the driving unit comprises:
a main plate connected to the holder and configured to be movable in upward and downward directions; and
a support extending upward from the main plate and having an upper portion on which the jig is disposed.

6. The apparatus of claim 5, wherein the driving unit further comprises a guide plate disposed on the upper portion of the support and connected to the jig to rotate the jig, and a rotating plate configured to rotate relative to the guide plate to guide the jig to expand the jig from a center portion to the outside.

7. The apparatus of claim 6, wherein the first actuator comprises:
a second driving motor driven to rotate the rotating shaft; and
a first connecting gear connecting the second driving motor and the guide plate and rotate the guide plate with respect to a center of the guide plate.

8. The apparatus of claim 6, wherein the second actuator comprises:
a third driving motor driven to rotate the rotating shaft; and
a second connecting gear that connects the third driving motor and the rotating plate so that the jig moves to a center side of the guide plate or from a center of the guide plate to the outside.

9. The apparatus of claim 6, wherein the driving unit further comprises a bearing unit configured to connect the guide plate and the support and allow the guide plate to freely rotate on the upper portion of the support.

10. The apparatus of claim 1, wherein the first actuator and the second actuator operate simultaneously.

11. The apparatus of claim 1, wherein the hairpin motor is an electric motor.

12. A vehicle comprising the apparatus of claim 11.

13. An electric vehicle comprising the apparatus of claim 1.
